(19) United States
(12) Patent Application Publication
(10) Pub. No.: US 2025/0175370 A1
(43) Pub. Date: May 29, 2025

(54) METHOD OF SEARCHING FOR THE REFLECTED SIGNAL INFLUENCE TABS OF AN EQUALIZER AND DEVICES FOR THE METHOD

(71) Applicant: VSI Co. Ltd., Seoul (KR)

(72) Inventors: Suwon Kang, Gyeonggi-do (KR); Jinbae Park, Gyeonggi-do (KR)

(73) Assignee: VSI Co. Ltd., Seoul (KR)

(21) Appl. No.: 18/957,810

(22) Filed: Nov. 24, 2024

(30) Foreign Application Priority Data
Nov. 29, 2023 (KR) 10-2023-0169738

(51) Int. Cl. H04L 25/03

(52) U.S. Cl. CPC H04L 25/03019; H04L 2025/03808

(57) ABSTRACT

A device according to the present invention includes: one or more calculation units configured to calculate correlation sums of binary divided first and second parts of the search range specified for a series of discrete digital signals having a unit time difference from each other, the discrete digital signals being specified based on a set code constant sequence, and a controller configured to specify as the search range one part in which a dominant value appears in one or more correlation sums for the first part and one or more correlation sums for the second part, each of which is calculated by the one or more calculation units, and cause the one or more calculation units to recalculate the correlation sums for each of the binary divided sub parts of the one part.

### RELATED PATENT APPLICATION

This application claims priority to Korean Patent Application No. 10-2023-0169738 filed Nov. 29, 2023, the entire contents of which are hereby incorporated by reference for all purposes.

### TECHNICAL FIELD

The present invention relates to techniques for processing signals received through a transmission channel, and more specifically, to equalization techniques for compensating for signal distortion in the transmission channel.

### BACKGROUND

When data is transmitted through a transmission channel between communication devices, the transmitted data signal is subject to inter-symbol interference (ISI). Inter-symbol interference appears in the form of a distorted signal as the signal of one transmitted symbol is interfered with other transmitted symbols, and along with other noise, it negatively affects the ability of a receiver to properly recover the transmitted signal. In a receiver, it is common to use an equalizer to remove this inter-symbol interference and accurately recover the transmitted symbols.

One of the main factors causing inter-symbol interference is a reflection of signals that occur at the transmission channel, for example at discontinuous point on the transmission line, and this reflection may have an influence of inter-symbol interference on a wide range of symbols. For example, a symbol currently detected by a receiver may be affected by inter-symbol interference from a symbol transmitted prior to several tens of symbols. Considering this point, the equalizer, especially a decision feedback equalizer (hereinafter, abbreviated as a “feedback equalizer”), has many taps, for example, several hundreds of tabs, which correspond to the range of symbols capable of being affected by the inter-symbol interference.

However, since only a small part of many taps provided in the feedback equalizer actually cause inter-symbol interference due to reflection, it is inefficient to reflect all of the many taps provided to remove the effects of inter-symbol interference due to reflection in the operation for adapting equalizer taps. Because of that, it is necessary to find the taps affected by inter-symbol interference due to reflection among the many taps and reflect only them in the removal of inter-symbol interference. Generally, according to the channel characteristics, interference components appear in random taps of the feedback equalizer. The tap where the interference component appears according to this randomness is called a floating tap.

Considering that the inter-symbol interference due to reflection can affect a wide range of symbols, when using a feedback equalizer provided with a large number of taps, it is possible to decide the floating tap by a method of checking whether the component of inter-symbol interference due to reflection appears for each tap.

However, if the floating tap is decided by individually checking each tap provided in the feedback equalizer, the time required for the decision increases in proportion to the number of taps provided in the feedback equalizer. Considering the large number of taps provided in the feedback equalizer, a method for deciding the floating tap more quickly is required.

### DETAILED DESCRIPTION

### Technical Problem

It is an object of the present disclosure to provide a device capable of quickly grasping a floating tap appeared by an inter-symbol interference component due to a reflected wave.

The object of the present invention is not limited to the object explicitly stated above, and of course includes the purpose of achieving effects that can be derived from the following specific and exemplary description of the present invention.

### Technical Solution

According to an aspect of the present invention, there is provided a device for deciding reflected wave influence taps of an equalizer, comprising: one or more calculation units configured to calculate correlation sums of binary divided first and second parts of the search range specified for a series of discrete digital signals having a unit time difference from each other, and a controller configured to specify as the search range one part in which a dominant value appears in one or more correlation sums for the first part and one or more correlation sums for the second part, each of which is calculated by the one or more calculation units, and cause the one or more calculation units to recalculate the correlation sums for each of the binary divided sub parts of the one part. Each of the one or more calculation units is configured to sequentially assign codes to each of the series of discrete digital signals based on a set code constant sequence prior to calculating the correlation sums.

In an embodiment according to the present invention, the one or more calculation units are formed in a plurality of units, and the code constant sequence set for each of the plurality of calculation units is one of the combinations of different code patterns from each other that continuous series of code constants can have.

In an embodiment according to the present invention, the set code constant sequence is selected from a list of code constant combinations provided in the controller in accordance with the status value of the component of the device. In this case, the device may be provided with the calculation units whose number is smaller than the number of the code constant sequences included in the list of the code constant combinations. Further, the list of code constant combinations may include code constant sequences in which some code constants repeated in the code constant sequence are different in number. Further, in the present embodiment, the plurality of calculation units may be provided so as to be no more than ½ the number of different cases from each other that may be possessed by the continuous series of code constants. In this case, the code constant sequences respectively set for the plurality of calculation units has different code constant patterns from each other in the series of code constants.

In an embodiment according to the present invention, the code constant sequence consists of a pattern in which a group of a specified number of consecutive code constants are repeated as units.

In an embodiment according to the present invention, the controller may be configured so as to decide the tap section of the equalizer corresponding to the one sub part as a floating tab, when a sub part in which a dominant value appears in the correlation sum calculated from one or more calculation units for each of the binary divided sub parts is for a previously specified number or less of discrete digital signals. The previously specified number may be equal to the number of code constants of the code constant group repeated in the code constant sequence.

In an embodiment according to the present invention, each of the one or more calculation units is configured to multiply the discrete digital signals belonging to the binary divided parts of the current search range, the code of which is assigned by the set code constant sequence, by an error signal to calculate the correlation sum. Here, the error signal corresponds to the difference between a digital signal at the present time and a symbol signal from which the digital signal at the present time is obtained. Further, the correlation sum may correspond to the average value of a plurality of correlation values obtained by multiplying the discrete digital signals presently belonging to the binary divided parts and the error signal each time the unit time passes.

In an embodiment according to the present invention, the code constant sequence applied to each of the one or more calculation units is set by the controller, and +1 or −1 of the set code constant sequence is individually multiplied by the series of discrete digital signals by a multiplier.

In an embodiment according to the present invention, the code constant sequence is applied to the one or more calculation units in a form in which a discrete digital signal is used as is, or is computed and used by a specific circuit element. This specific circuit element may be either a multiplier that multiplies by −1 or a complementor.

In another aspect according to the present invention, there is provided a method for deciding reflected wave influence taps of an equalizer, comprising: a first step of sequentially assigning codes based on each of one or more code constant sequences set for each of a series of discrete digital signals having a unit time difference from each other, and specifying binary divided parts of a search range for one or more discrete digital signal sequences to which codes are assigned; a second step of calculating correlation sums of the binary divided parts for each of the one or more discrete digital signal sequences; a third step of deciding one part in which a dominant value appears between one or more correlation sums calculated for one of the binary divided parts and one or more correlation sums calculated for the other of the binary divided parts, and a fourth step of deciding the tap section of the equalizer corresponding to the previously specified one part as a floating tap when the decided one part is for a previously specified number or less of discrete digital signals, and otherwise, specifying the one part as the search range and proceeding again from the first step.

### Advantageous Effects

According to at least one embodiment of the present invention described above or described in detail below with the accompanying drawings, the method of searching reflected signal influence taps of an equalizer involves searching the floating tab in which the inter-symbol interference component due to the reflected wave appears while binary dividing the taps of the feedback equalizer, so that the floating tabs can be decided very quickly for a large number of taps.

In addition, according to the present invention, the floating tab is decided without individually checking the correlation for each tap of the feedback equalizer. Because of that, the circuit for deciding the floating tab can be relatively simplified compared to the circuit for individually finding the correlation. Furthermore, multiplication operations of digital signals, which is relatively complex and requires a relatively long calculation time, is less used to decide the floating tab.

### BRIEF DESCRIPTION OF THE DRAWINGS

FIG. 1 is a block diagram illustrating a configuration of a receiver according to an embodiment of the present invention.

FIG. 2 is a detailed block diagram of a floating tap decision unit of FIG. 1 configured according to an embodiment of the present invention.

FIG. 3 lists all terms reflected in the correlation sum accumulated in the accumulator of FIG. 2 according to an embodiment of the present invention.

FIG. 4 illustrates examples of code constant combinations in which a pattern of a code constant sequence is repeated periodically in a limited tap range according to one embodiment of the present invention.

FIG. 5 is a diagram illustrating a process of searching a floating tab while binary dividing a tap group of a search target according to an embodiment of the present invention.

FIG. 6 illustrates examples of a circuit in which a combination of code constants is selectively or hardware-fixed and applied to a discrete digital signal according to another embodiment of the present invention.

FIG. 7 illustrates an example in which a list of code constant combinations is configured by including code constant sequences with different repetition cycles according to yet another embodiment of the present invention.

### DETAILED DESCRIPTION

Hereinafter, various embodiments of the present invention will be described in detail with reference to the accompanying drawings.

In the following description of embodiments according to the present invention and the accompanying drawings, the same numbers denotes the same components unless specified otherwise. Of course, for convenience of explanation and ease of understanding, the same components may also be denoted by different numbers, if necessary.

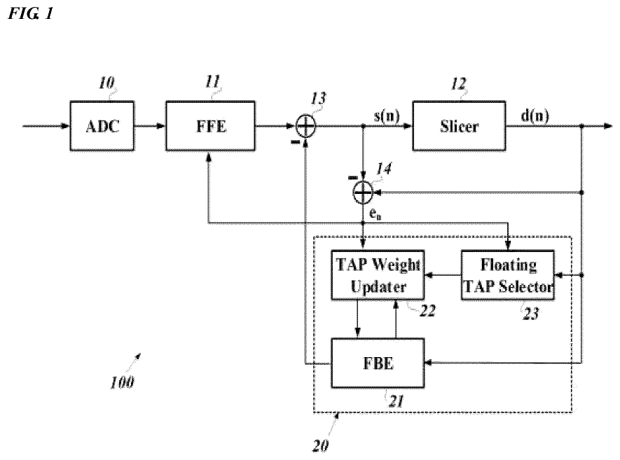

FIG. 1 is a block diagram illustrating a configuration of a receiver according to an embodiment of the present invention. A receiver 100 of the present embodiment is configured to include an AD converter 10 that digitally samples a received signal, a feedforward equalizer 11 that equalizes and outputs a digital output signal of the AD converter 10 in symbol units, a slicer 12 that decides a corresponding digital signal from the symbols of the equalized signal, and a decision feedback equalization unit 20 that outputs a cancellation signal that removes inter-symbol interference components between symbols in the equalized signal based on a digital signal d(n) and an error signal (eₙ=d(n)−s(n)) output by the slicer 12.

The decision feedback equalization unit 20 is configured to include a feedback equalizer 21 that outputs a cancellation signal from the signal components corresponding to each tap according to the set tap coefficients, a floating tap decision unit 23 that decides a floating tap that an inter-symbol interference component exhibits due to a reflected wave from the digital signal d(n) of the slicer 12, and a tap updater 22 that dynamically sets the coefficients of the floating taps based on the error signal eₙ and the current tap coefficients of the feedback equalizer 21.

The receiver 100 is configured such that the components of the cancellation signal output by the feedback equalizer 21 are removed by the first adder 13 from the equalized signal output by the feedforward equalizer 11, and the second adder 14 provides an error signal(eₙ) obtained by subtracting the signal(s(n)) input thereto from the digital signal d(n) output by the slicer 12.

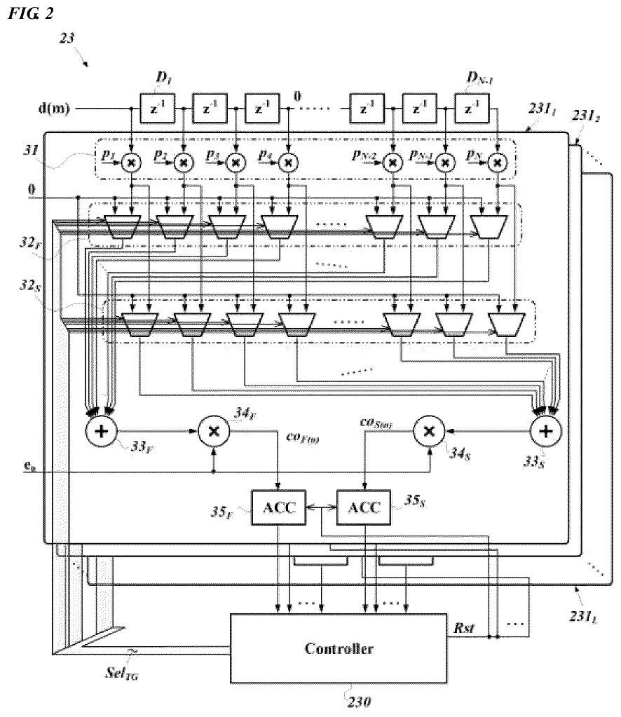

FIG. 2 is a detailed block diagram of the floating tap decision unit 23 configured according to an embodiment of the present invention. The floating tap decision unit 23 of the present embodiment is configured to include: a series of delay units (Dᵢ, i=1, . . . , N−1) connected in a chain so as to receive input of the output digital signal (d(n)) of the slicer 12, and sequentially delay and output it by a unit time, a plurality of correlation sum calculation units (23lᵢ, i=1, 2, . . . , L) that receive all input digital signals (d(m−i), i=0, . . . , N−1) (hereinafter referred to as ‘discrete digital signal sequence’) having a difference in each unit time, and calculate the correlation sum for each of the binary divided tap groups of the specified search target, and a controller 230 that controls the calculation of the correlation sum of each correlation sum calculation unit 23lᵢ and decides the floating tap in a binary notation manner by checking the dominant value of the calculated correlation sums. Here, the dominant value refers to the correlation sum whose size is the largest regardless of the code, or the correlation sum whose absolute value is the largest.

The digital signal d(m) applied to the most advanced delay unit D₁ in a series of delay units (Dᵢ, i=1, 2, . . . , L) connected in a chain may be a signal that is delayed in advance by several units of time from the output digital signal d(n) of the slicer 12, considering the range of the possibility that interference components due to reflected waves may appear at the taps of the feedback equalizer 21, that is, considering the minimum tap distance to start searching the floating tap from the tap in which the current signal component is obtained.

And, each correlation sum calculation unit 23lᵢ is configured to include: a code multiplier set 31 that multiplies each of the discrete digital signal sequences d(m−i) by a specified code constant (pᵢ, i=1, . . . , N) and outputs the result, a pair of mux sets 32_{F} and 32_{S} each composed of a series of muxes that select and output one of the outputs of one multiplier in the code multiplier set 31 and a zero signal, data adders 33_{F} and 33_{S} that adds the output signals of the muxes of one mux set, data multipliers 34_{F} and 34_{S} that outputs a correlation value obtained by multiplying the output signal of the data adders 33_{F} and 33_{S} and the error signal (eₙ) output by the second adder 14, and accumulators 35_{F} and 35_{S} that accumulate the correlation values output by the data multipliers 34_{F} and 34_{S}.

The correlation sum calculation unit 23lᵢ constituting the floating tab decision unit 23 is provided by the number of combinations of the code constants (pᵢ, i=1, . . . , N) multiplied by the sign multiplier set 31, and the combinations of the code constants applied to each correlation sum calculation unit 23lᵢ are different from each other. The code constant (pᵢ) is specified as a value of +1 or −1, and thus performs the function of assigning a code to a discrete digital signal. The pattern of the code constant sequence can be repeated in a group unit of a predetermined number of code constants.

In an embodiment in which the pattern of the code constant sequence is repeated, the correlation sum calculation unit 23lᵢ is provided corresponding to the combinations of code constants that are different from each other by the number of the cases of the code pattern that can be made into +1 and −1 for a limited number of code constant groups. Therefore, the number of correlation sum calculation units to be provided is greatly reduced compared to the case of applying a code constant combination in which the code constant pattern is not repeated. Another embodiment according to the present invention may be provided with a correlation calculation unit 23lᵢ that is half the number of code patterns that can be made into +1 and −1 for a limited number of code constant groups.

The technical principle by which the combination of code constants is determined and the technical operation of the combination are specifically explained in the relevant sections below.

The floating tap decision unit 23 configured as above operates as follows to decide the floating tap.

When the transmission channel training starts in a receiver 100, the controller 230 applies a selection signal Sel_{TG} to each mux of the first mux set 32_{F} and the second mux set 32_{S}, so that the discrete digital signal sequence (d(m−i), i=0, . . . , N−1) is binary divided, and made to output from each mux set 32_{F} and 32_{S}. At this time, the signal output from each mux to which the selection signal Sel_{TG} is applied is a signal obtained by multiplying the discrete digital signal d(m−i) by the code constant (pi+1). The output of a mux to which the selection signal Sel_{TG} is not applied becomes a zero signal.

Thereby, the signal added and output by a first data adder 33_{F} and a second data adder 33_{S} becomes the sum of each part of the binary divided discrete digital signal sequence, and each of these sums is multiplied by the current error signal eₙ in the next data multipliers 34_{F} and 34_{S} and output. The signals COF₍ₙ₎ and COS₍ₙ₎ output from each data multiplier 34_{F} and 34_{S} are expressed by the following Mathematical Equation 1.

$$\begin{matrix}{co}_{F ( n )} = {\sum }_{k = 0}^{\frac{N}{2} - 1} {p}_{k + 1} \cdot d ( m - k ) \cdot {e}_{n} , \\ {co}_{S ( n )} = {\sum }_{k = N / 2}^{N - 1} {p}_{k + 1} \cdot d ( m - k ) \cdot {e}_{n}\end{matrix} \qquad [ Mathematical Equation 1 ]$$

In Mathematical Equation 1, m=n−d_{def_Tab}. Here, d_{def_Tab} corresponds to the minimum tap distance specified above for the possible range of floating taps.

The output signals COF₍ₙ₎, COS₍ₙ₎ of each data multiplier 34_{F}, 34_{S} expressed by Equation 1 is the sum of correlations in which the digital signals of each binary divided part of the discrete digital signal sequence affect the current data by inter-symbol interference at the current point in time, assuming that all code constants are 1, and this correlation sum is initially added to respective accumulators 35_{F} and 35_{S}.

The controller 230 causes the process of adding the correlation sums to the accumulators 35_{F} and 35_{S}, respectively, to proceed each time the slicer 12 outputs the next digital signal, and this process proceeds by a predetermined number of times N_{T}, so that each accumulator 35_{F}, 35_{S} generates the correlation sums accumulated up to that point, as represented by Mathematical Equation 2.

$$\begin{matrix}Sum \{ {co}_{F} \} = {\sum }_{i = 0}^{{N}_{T} - 1} {co}_{F ( n + i )} , \\ Sum \{ {co}_{S} \} = {\sum }_{i = 0}^{{N}_{T} - 1} {co}_{S ( n + i )}\end{matrix} \qquad [ Mathematical Equation 2 ]$$

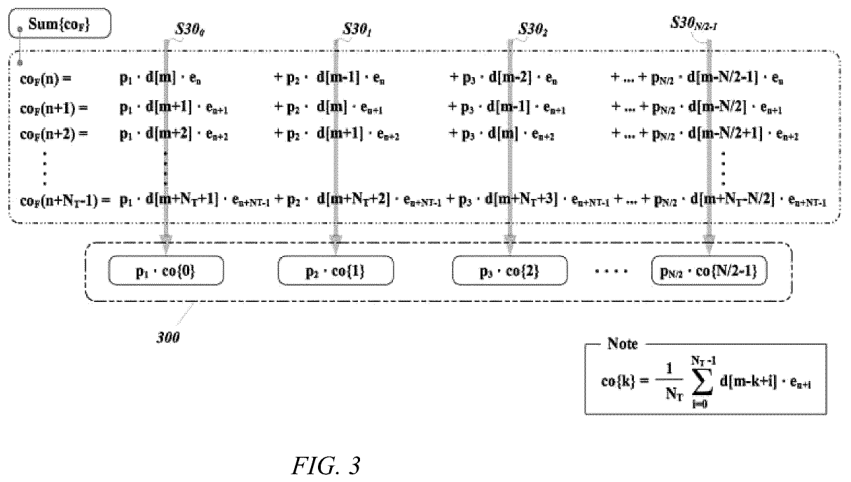

FIG. 3 lists the total terms added to the correlation sum (Sum{COF}) accumulated by the first accumulator 35_{F}. The sum (Sum{COF}) of the listed total terms is equal to the result of vertically adding each term (S30ᵢ, i=0, 1, . . . , N/2−1).

And, the average value of each vertical summation value (sum_{c_k}) expressed as in Equation 3, i.e., sumc_k/N_{T}, is the value obtained by multiplying the code constant Pₖ₊₁ by the average value of the total influence of interference that distorts the current signal (d(n+i), i=0, 1, . . . , NT−1) at each point in time by a series of NT discrete digital signals d(m−k+i)(i=0, 1, . . . , N_{T}−1).

$$\begin{matrix}{sum}_{c \_ k} = {p}_{k + 1} \cdot {{\sum }_{i = 0}}^{{N}_{T} - 1} d [ m - k + i ] \cdot {e}_{n + i} , \\ k = 0 , 1 , 2 , …\end{matrix} \qquad [ Mathematical Equation 3 ]$$

The average value of the total influence of interference, sum_{c_k}/N_{T}, corresponds to the correlation of the k-th tap based on the tap at the smallest distance d_{def_Tab} from the signal tap in the feedback equalizer 21. The reason why the discrete digital signal d(m−k) corresponds to the k-th tap is that the discrete digital signal d(m−k) delayed by k time units from d(m) appears at a tab k distance away from the tab of the feedback equalizer 21 at which the d(m) component appears at the current time point.

Therefore, each result calculated vertically in FIG. 3 is a value obtained by multiplying each tap correlation, starting from the correlation for the 0th tap (hereinafter, abbreviated as ‘tap correlation’) to the correlation of the N/2−1th tap, on the basis of the tap at the minimum distance d_{def_Tab}, by the code constant assigned to each tab, and the sum of these values 300 becomes the sum of the tap correlations of this part when all the code constants are 1, and the sum of these tap correlations becomes the accumulation result of the first accumulator 35_{F}.

Similarly, the second accumulator 35_{S} has the result of the sum of the tap correlations of the binary divided other parts.

Therefore, the controller 230 compares the accumulated values of the two accumulators 35_{F} and 35_{S} with each other, and decides the part in which the accumulator showing the dominant value indicating the greater degree of interference influence on the signal, i.e., the greater sum of tap correlation, is responsible for accumulation as the dominant part.

As described in the above configuration, the receiver 100 is provided with a plurality of correlation sum calculation units 23lᵢ, and each correlation sum calculation unit 23lᵢ performs the above-mentioned procedure in a similar manner, so that the sum of the tap correlations of the binary divided parts (hereinafter, abbreviated as ‘correlation sum’) is calculated by both accumulators 35_{F} and 35_{S} of the correlation sum calculation unit 23lᵢ. These correlation sums may include a correlation sum in which any tap correlation is multiplied by −1 according to one of the different code constant combinations assigned to the correlation sum calculation unit 23lᵢ. The reason for specifying different code constant combinations in this way and simultaneously calculating the correlation sums for the binary divided parts in the correlation sum calculation units 23lᵢ corresponding to the number of combinations is explained below.

As explained with reference to FIG. 3, each tap correlation (co(k), k=0, 1, 2, . . . ) may have a negative value. Therefore, if all the code constants are 1, the negative tap correlation does not increase the correlation sum but rather decreases it. For example, in the first part including two taps showing the effect of interference due to the reflected wave, when assuming that the tap correlations are +8 and −6, respectively, and the tap correlations in the other taps of the second part are +1,+1,+1, the second part having a correlation sum of +3 is selected as the dominant part instead of the first part having a correlation of +2 if the correlations of each part are obtained and compared without considering the code constant. That is, an unintended operation is performed in which the first part, which includes taps where the interference effect due to reflected waves appears and in which the sum of the magnitudes of the tap correlations is 14, is not selected.

In order to reliably prevent such errors that may occur in deciding the dominant part when one or more tap correlations have a value with a different sign from the other tap correlations, it is necessary to make all the tap correlations (co {k}, k=0, 1, 2, . . . ) have the same code so that they are not subtracted from each other before being added in the correlation sum. However, since the code constant (pₖ₊₁) is multiplied by the discrete digital signal before each tap correlation is calculated, the multiplication must be performed while not knowing the sign of the tap correlation.

For this reason, correlation calculation units 23lᵢ are provided corresponding to the number of code constant combinations according to the positive or negative case that the tap correlation can take, so that the correlation sum for each binary divided parts is calculated by both accumulators 35_{F} and 35_{S} of each correlation calculation unit 23lᵢ. In this way, the correlation sums found for one part of all the correlation calculation units 23lᵢ will include at least one correlation to which tap correlations of the same code have been added, and the absolute value of this correlation sum will be the largest value among the correlation sums.

Therefore, the controller 230 compares the absolute values of the accumulated values that each first accumulator 35_{F} of the correlation sum calculation units 23lᵢ maintains as the final result with each other to find the largest value, and the maximum value compares with the maximum value among the absolute values of the second accumulators 35_{S}, so that the part having the larger dominant value is decided as the dominant part. This type of decision method prevents an error in deciding the dominant part that may occur when tap correlations having different codes from each other are obtained in the same part.

Since a feedback equalizer can generally have several hundreds of taps, the search range for finding the floating taps can be at least hundreds of taps, and the number of code constant combinations for this number of taps is too large. Therefore, it is necessary to limit the number of combinations of code constants and select a number that allows for parallel implementation of the correlation calculation unit.

For this purpose, in an embodiment according to the present invention, a group of consecutive taps where the influence of interference by reflected waves may occur is limited, and a combination of code constants is selected so that the code constant sequence is repeated based on the number of taps in the limited group of consecutive taps.

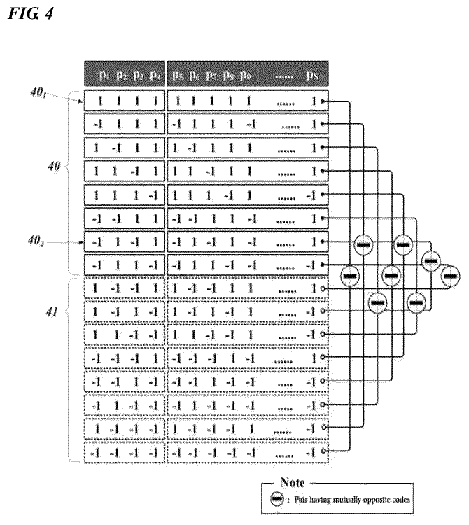

FIG. 4 illustrates examples of a combination of code constants when the limited group of consecutive taps is made of four taps.

The number of the combinations of four code constants each capable of selecting +1 or −1 is 16 as illustrated. Half of these are combinations having opposite codes from each other, and therefore, if the controller 230 compares the absolute values of the accumulated values as described above, the pairs 41 having opposite codes from each other are excluded from the combinations of code constants, and only the remaining combinations 40 are taken as code constant combinations, and a correlation calculation unit can be provided for these combinations 40.

To express the example of FIG. 4 more generally, when the number of consecutive tap groups is limited to N_{TG}, correlation calculation units are provided for each of 2^{NTG-1} (=2^{NTG-1}/2) code constant combinations.

Meanwhile, after one of binary divided parts is decided as the dominant part as described above, the controller 230 performs the above operation again for the discrete digital signals of the decided dominant part.

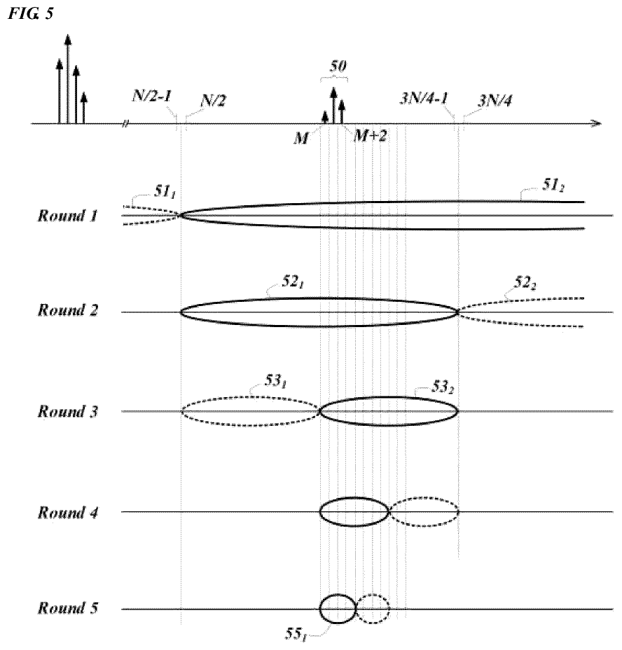

FIG. 5 is a diagram illustrating a process of searching a floating tab while binary dividing a tap group of a search target according to an embodiment of the present invention.

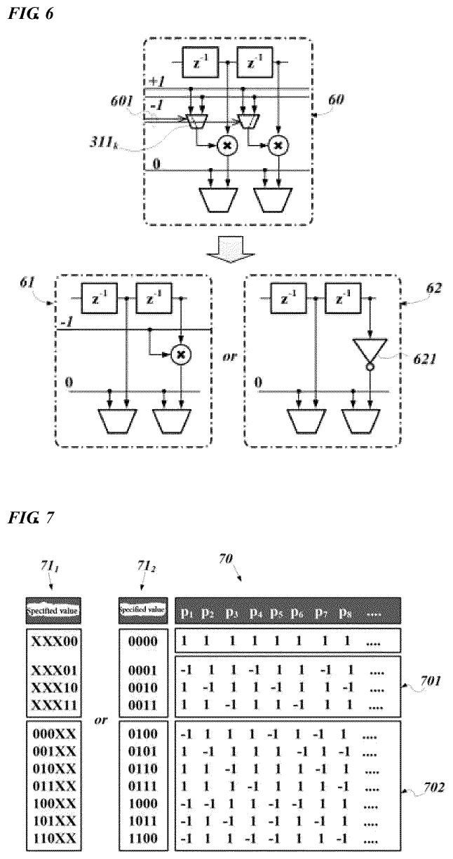

FIG. 6 is a schematic diagram showing that the final dominant part, i.e., the floating tap, is decided according to this process. In discrete digital signals, d(n−d_{def_Tab}−k) (k=M, M−1, M−2, M>N/2, and M+2<3N/4−1. And, k corresponds to the index of the tap based on the tap at the minimum tap distance d_{def_Tab}. It is assumed to be a reflected wave component interfering with the current discrete digital signal (d(n)).

In accordance with the above assumption, in the decision of the first dominant part described above, the post-part 51₂ (in the binary divided parts, it refers to a tap of a relatively delayed signal, and the other parts are called “pre-parts”) is decided as the dominant part. Therefore, in order to decide the binary divided dominant parts for the part 51₂ after being decided as the current dominant part, the controller 230 applies a selection signal (Sel_{TG}) to each correlation sum calculation unit 23lᵢ so that only the discrete digital signals of the binary divided pre-part (from N/2 to 3N/4−1) of the post-part 51₂ are output from each mux in the first mux set 32_{F}, and only the discrete digital signals of the binary divided post-part (from 3N/4 to N−1) of the post-part 51₂ are output from each mux in the second mux set 32_{S}. Prior to this, a reset signal is applied to the accumulators 35_{F} and 35_{S} of each correlation sum calculation unit 23L, so that the currently accumulated value is initialized to 0.

Depending on the application of the selection signal (Sel_{TG}) of the controller 230, the correlation sums for the binary divided pre-parts 521 in the range reduced by ½ from the initial search range are calculated by the first accumulator 35_{F} of each correlation sum calculation unit 23lᵢ, and the correlation sums for the post-part 522 are calculated by the second accumulator 35_{S}.

As described above, the controller 230 compares the largest absolute value in the values of the first accumulators 35_{F} having the largest absolute value in the values of the second accumulators 35_{S} to include a tab in which a reflected wave component 50 appears, so that pre-part 521 for which a greater correlation is required is decided as the dominant part, and this decided dominant part is set as the search range, and the binary divided dominant parts 532 are again decided.

The controller 230 performs the above-mentioned process of continuously searching the decided dominant part while performing binary division until the number of taps belonging to the decided dominant part does not exceed a predetermined reference value. This reference value may be equal to the number of taps in the limited consecutive tap group. The example of FIG. 6 illustrates the case where the predetermined reference value is 4, and shows that finally, based on the tap section in which correlation for tap correlation co {M} to co {M+3} was obtained, i.e., the tap with the minimum distance d_{def_Tab} from the signal tap, the part 55₁ corresponding to the M-th to “M+3”th taps was decided to be the dominant part.

The tap of the dominant part 55₁ finally decided in this manner is confirmed as the floating tap. The controller 230 sets information regarding this confirmed floating tap in the tap updater 22.

When information regarding the floating tap is set, the tap updater 22 continuously performs an operation of adjusting the tap coefficients in a direction in which components for taps other than the signal tap are eliminated based on the current tap coefficients of the feedback equalizer 21 and the currently obtained error signal (eₙ) and resetting the feedback equalizer 21.

If the tap correlation of one or two taps in the previously limited consecutive tap group is relatively large and noticeable, the combination of sign constants can be further reduced and specified. For example, if the reflected wave component appears prominently at two taps in a limited group of consecutive taps and the component is weak at the remaining taps, the influence of the possibility of subtraction of the tap with the weak component can be ignored, and only two combinations 401 and 402 in which the code constant sequences for the two consecutive taps where the reflected wave component is prominent are different from each other can be selected and applied.

Meanwhile, in an embodiment according to the present invention, the combinations of code constants determined as described above are recorded in advance in the controller 230. When the controller 230 is started, the recorded code constant combinations are read out in order, and each code constant of the corresponding combination is input to each multiplier of the code multiplier set 31 of each correlation calculation unit 23lᵢ.

In order to selectively apply +1 or −1 to each multiplier in this way, an embodiment according to the present invention may be configured with circuit 60 such that the code constant applied to each multiplier is applied through the sign selection mux 311ₖ, as illustrated in FIG. 6. In this code selection mux 311ₖ, constant signals +1 and −1 are applied to the input terminals, respectively, and one of the input values is applied to the output terminal, i.e., the code multiplier, by the applied selection signal 601. In the circuit 60 configured so that the code constant is applied to the code multiplier in this way, the controller 230 converts the code constant of +1 or −1 included in the corresponding combination into the corresponding selection signal for the code selection mux 311ₖ and uses it.

In the above-mentioned embodiment, the receiver 100 is provided with a plurality of correlation calculation units to which each of different code constant combinations is applied, however, in another embodiment according to the present invention, the receiver may be configured to be provided with different code constant combinations, but be provided with only one correlation calculation unit. This embodiment can be applied to a receiver applied to a transmission channel with low variability characteristics. In this embodiment, a list of code constant combinations that can be selected according to the characteristics of the transmission channel is provided in the controller 230, and one of the combinations is selected from the list by the state value of a component (dip switch, jumper, etc.) that is separately provided in the receiver 100 and can manually select an arbitrary value from a designated range, and is applied to the code multipliers of a single correlation calculation unit.

In this embodiment, the controller 230 compares only the correlation sums obtained from the accumulators 35_{F} and 35_{S} of the single correlation sum calculation unit to decide the dominant part.

Furthermore, in the present embodiment, the list 70 of code constant combinations may include code constant patterns with different code constant repetition periods, as illustrated in FIG. 7. The illustrated example is for the case where the number of repeating code constant sequences is 3 (701) and 4 (702). In addition, the list may include code constant patterns each having a repetition period of several numbers in a mutual relationship.

According to the present invention, in an embodiment in which a combination of code constants selected from a list of combinations of code constants is applied to the calculation of correlation sum, a plurality of correlation sum calculation units may be provided to configure a receiver. In this case, however, the number of correlation calculation units provided will be far smaller than the number of code constant combinations included in the list. As shown in FIG. 7, when list 70 of code constant combinations is recorded in the controller 230, two correlation calculation units are provided in the receiver. A component for selecting values 71₁ and 71₂ specified for two combinations of code constants from the list 70 is also provided in the receiver 100. When the second specified value 71₂ in the example is applied to the list of combinations of code constants, the number of components capable of setting each specified value is provided corresponding to the number of correlation sum calculation units.

In another embodiment according to the present invention, the combinations of code constants can be fixed in hardware, without being selected according to the signal distortion characteristics of the transmission channel. For example, if a floating tap decision unit 23 to which a specific combination of code constants is applied is widely used, the floating tap decision unit may not be configured as a circuit n a form in which circuit elements are applied only to a discrete digital signal to which a sign constant of −1 is applied, for example, in a form 61 in which a sign multiplier multiplied by a constant signal of −1 is applied, or in a form 62 in which a complementary unit 621 is applied.

The various embodiments of the method for searching the reflected signal influence tab of an equalizer according to the present invention and the equipment for the method, which have been specifically described so far, and the configurations and actions described in the embodiments, can be selectively combined with each other in various ways, except for the cases where they are mutually incompatible.

The above-mentioned embodiments of the present invention have been disclosed for illustrative purposes, and those skilled in the art will appreciate that various improvements, modifications, substitutions or additions can be made in the embodiments without departing from the technical spirit and scope of the present invention disclosed in the appended claims.

Description of Reference Numerals

| | |
|---|---|
| 10: AD converter | 11: feedforward equalizer |
| 12: slicer | 13: first adder |
| 14: second adder | 20: decision feedback equalizer |
| 21: feedback equalizer | 22: tap updater |
| 23: Floating tap decision unit | 31: code multiplier set |
| 32_{F}: first mux set | 32_{S}: second mux set |
| 33_{F}: first data adder | 33_{S}: second data adder |
| 34_{F}: first data multiplier | 34_{S}: second data multiplier |
| 35_{F}: first accumulator | 35_{F}: second accumulator |
| 100: receiver | 230: controller |
| 231ᵢ: correlation sum calculation unit | 311ₖ: code selection mux |
| 621: complementor | |

1. A device for deciding reflected wave influence taps of an equalizer, comprising:
one or more calculation units configured to calculate correlation sums of binary divided first and second parts of the search range specified for a series of discrete digital signals having a unit time difference from each other, and
a controller configured to specify as the search range one part in which a dominant value appears in one or more correlation sums for the first part and one or more correlation sums for the second part, each of which is calculated by the one or more calculation units, and cause the one or more calculation units to recalculate the correlation sums for each of the binary divided sub parts of the one part,
wherein each of the one or more calculation units is configured to sequentially assign codes to each of the series of discrete digital signals based on a set code constant sequence prior to calculating the correlation sums.

2. The device according to claim 1, wherein:
the one or more calculation units are formed in a plurality of units, and
the code constant sequence set for each of the plurality of calculation units is one of the combinations of different code patterns from each other that continuous series of code constants can have.

3. The device according to claim 1 or 2, wherein:
the set code constant sequence is selected from a list of code constant combinations provided in the controller in accordance with the status value of the component of the device.

4. The device according to claim 3, wherein:
the device is provided with the calculation units whose number is smaller than the number of the code constant sequences included in the list of the code constant combinations.

5. The device according to claim 3, wherein:
the list of code constant combinations includes code constant sequences in which some code constants repeated in the code constant sequence are different in number.

6. The device according to claim 2, wherein:
the plurality of calculation units are provided so as to be no more than ½ the number of different cases from each other that may be possessed by the continuous series of code constants, and
the code constant sequences respectively set for the plurality of calculation units has different code constant patterns from each other in the series of code constants.

7. The device according to claim 1 or 2, wherein:
the code constant sequence consists of a pattern in which a group of a specified number of consecutive code constants are repeated as units.

8. The device according to claim 1, wherein:
the controller is configured so as to decide the tap section of the equalizer corresponding to the one sub part as a floating tab, when a sub part in which a dominant value appears in the correlation sum calculated from one or more calculation units for each of the binary divided sub parts is for a previously specified number or less of discrete digital signals.

9. The device according to claim 8, wherein:
the previously specified number is equal to the number of code constants of the code constant group repeated in the code constant sequence.

10. The device according to claim 1, wherein:
each of the one or more calculation units is configured to multiply the discrete digital signals belonging to the binary divided parts of the current search range, the code of which is assigned by the set code constant sequence, by an error signal to calculate the correlation sum,
wherein the error signal corresponds to the difference between a digital signal at the present time and a symbol signal from which the digital signal at the present time is obtained.

11. The device according to claim 10, wherein:
the correlation sum corresponds to the average value of a plurality of correlation values obtained by multiplying the discrete digital signals presently belonging to the binary divided parts and the error signal each time the unit time passes.

12. The device according to claim 1, wherein:
the code constant sequence applied to each of the one or more calculation units is set by the controller, and +1 or −1 of the set code constant sequence is individually multiplied by the series of discrete digital signals by a multiplier.

13. The device according to claim 1, wherein:
the code constant sequence is applied to the one or more calculation units in a form in which a discrete digital signal is used as is, or is computed and used by a specific circuit element,
wherein the specific circuit element is either a multiplier that multiplies by −1 or a complementor.

14. A method for deciding reflected wave influence taps of an equalizer, comprising:
sequentially assigning codes based on each of one or more code constant sequences set for each of a series of discrete digital signals having a unit time difference from each other, and specifying binary divided parts of a search range for one or more discrete digital signal sequences to which codes are assigned;
calculating correlation sums of the binary divided parts for each of the one or more discrete digital signal sequences;
deciding one part in which a dominant value appears between one or more correlation sums calculated for one of the binary divided parts and one or more correlation sums calculated for the other of the binary divided parts, and
deciding the tap section of the equalizer corresponding to the previously specified one part as a floating tap when the decided one part is for a previously specified number or less of discrete digital signals, and otherwise, specifying the one part as the search range.

15. The method as in claim 14, comprising:
sequentially reassigning codes based on each of one or more code constant sequences set for each of a series of discrete digital signals having a unit time difference from each other, and respecifying binary divided parts of a search range for one or more discrete digital signal sequences to which codes are assigned.
